(19) United States
(12) Patent Application Publication
(10) Pub. No.: US 2005/0175735 A1
(43) Pub. Date: Aug. 11, 2005

(54) Soy sour cream compositions and methods of preparation

(76) Inventors: N.R. Gandhi, River Hills, WI (US); Victoria Lynn Palmer Skebba, Cedarburg, WI (US); Harlan R. Hackbarth, Allenton, WI (US); Manxiang Chen, Grafton, WI (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/772,526

(22) Filed: Feb. 5, 2004

(51) Int. Cl. A23L 1/20

(52) U.S. Cl. 426/46

(57) ABSTRACT

Soy sour cream compositions together with methods for preparation are disclosed, such compositions utilizing a soy constituent and thermophilic bacterial cultures to provide a sour cream composition having the organoleptic properties of dairy sour cream and the health and nutritional benefits of soy. The soy sour cream compositions of the present invention also exhibit increased shelf life and room temperature stability over traditionally prepared dairy sour cream products.

### FIELD OF THE INVENTION

This invention is related to fermented soy-based products, and more particularly to soy sour cream compositions and related methods of preparation. The inventive compositions of the present invention contain the natural components and health and nutritional benefits of soy, yet have a taste and texture similar to dairy sour cream.

### BACKGROUND OF THE INVENTION

The popularity of substituted milk-based products, and in particular, soy products, has dramatically increased in recent years. Not only are soy based products a staple in many vegetarian and vegan diets, but a substantial number of people are realizing the health and anti-aging benefits of soy as a regular part of a healthy, well balanced diet.

Soy is a valuable source of protein for use as a substitute for animal protein in numerous animal based products. Soy contains lower levels of saturated fats and higher levels of omega-3 fatty acids than dairy products. In addition, soy contains other essential vitamins and minerals, such as B vitamins, calcium, iron and zinc. High in nutritional content, soy has been linked to many preventative and therapeutic health benefits such as reducing the occurrence of cardiovascular disease, cancer and osteoporosis, and the alleviation of menopausal symptoms. Soy products can also be a lower calorie or lower fat alternative to dairy products.

Soy is easily digested, does not contain lactose, and is naturally free of cholesterol. Individuals who are lactose-intolerant or on restricted cholesterol intake diets are able to substitute dairy or animal based products with products made from soy, without any adverse health effects. Indeed, soy milk and soy-based infant formulas are commonly used in place of dairy milk for individuals who are lactose-intolerant. Further, non-dairy substitutes, such as soy, are ideal for individuals who suffer from allergic reactions to animal's milk, such as individuals with respiratory disorders or eczema.

Additionally, soy protein is a much less expensive and more readily available protein source than animal and dairy based proteins.

Accordingly, the demand for additional high quality and appealing soy-based alternatives in place of commonly used animal-based food products is increasing. In particular, there is a need for additional soy-substituted dairy products, such as substitutes for dairy sour cream and dairy sour cream products, such as dips, dressings and sauces. Natural dairy sour cream is a cultured dairy product typically having a fat content of not less than 18 percent (as required by the United States Department of Agriculture). In addition, there are lower fat varieties of dairy sour cream such as reduced fat (less than 13.5% fat), light (less than 9.0% fat), low fat (less than 6.0% fat) and nonfat (less than 1.0% fat). Dairy sour creams can be difficult to cook with and tend to separate when used in hot or sour food preparations.

Dairy sour creams are manufactured with pasteurized milk cultured with mesophilic bacteria cultures having a fermentation range between about 15 to 42 degrees Celsius, preferably between about 30 to 35 degrees Celsius. Fermentation of dairy milk with mesophilic bacteria causes the production of lactic acid which not only coagulates (thickens) the milk, but also acidifies the milk, attributing to the taste and texture of typical dairy sour creams. Dairy sour creams have limited shelf stability, even under refrigeration, due to the presence of active mesophilic bacteria in the finished sour cream product. After packaging, ongoing bacterial activity continues resulting in a change in flavor (increasing acidity of the product), loss of viscosity and water separation of the product (known as syneresis). Typically, natural dairy sour creams are not stable for more than about fourteen days before water separation and change of taste occur.

Crème fraiche, a French dairy sour cream product, contains about 45-50% fat and is cultured with a thermophilic bacteria culture having a fermentation range between about 30 to about 50 degrees Celsius. Crème fraiche is often used in cooking; however, it contains a rather high fat and cholesterol content. Like other dairy sour creams, crème fraiche contains active cultures, lending to a limited shelf life.

Soy substitutes for these dairy cream products, such as soft and silken soy tofus, have been used in place of dairy sour cream in dips and spreads. However, these products lack the taste, texture and appearance of dairy sour cream. Furthermore, tofus are difficult to substitute into dips, dressings and other recipes calling for dairy sour cream. In addition, like dairy products, tofus have a limited shelf life and are easily spoiled without proper storage.

Attempts have been made to produce soy-based sour cream products from soy milk utilizing the methods used for the production of dairy sour cream. However, use of mesophilic culture strains with a soy-base produces a sour cream product with “off” flavors, poor body and texture—without the aroma typically associated with a dairy sour cream product. In addition, many soy based sour cream products do not hold up well during cooking, and tend to separate or curdle, rendering them poor substitutes for dairy sour creams.

There is a desire for non-dairy sour cream products possessing the taste, aroma, texture and appearance of dairy sour cream. In particular, there is a need for soy-based sour cream products having the demonstrated health benefits of other soy products, such as lactose and cholesterol free characteristics. In addition, such non-dairy sour cream products must contain desirable cooking characteristics, such as the ability to be used in a variety of recipes including hot or sour food dishes without separation or degradation.

### SUMMARY OF THE INVENTION

In light of the foregoing, there is a demonstrated need for soy-based sour cream products that have the same appearance, taste, texture and aroma of traditional dairy-based sour cream products, but which contain the health and nutritional benefits associated with soy foodstuffs.

Accordingly, it is a primary objective of this invention to provide soy sour cream compositions and methods of preparation of such compositions having similar organoleptic qualities as dairy sour cream. It can be a related objective of the present invention to provide soy sour cream compositions utilizing a wide variety of soy-based starting materials, including whole soybean material, which is naturally fermented using thermophilic bacterial cultures, wherein the soy sour cream compositions of the present invention maintain their flavor, texture and quality longer than traditional dairy sour creams.

It is another objective of the present invention to provide substantially aseptic soy-based sour cream products having increased room temperature and shelf-life stability over dairy sour creams and soy sour cream products of the prior art. It is a related objective of the present invention to provide soy sour cream products that can be incorporated into recipes that traditionally call for dairy sour creams, wherein the soy sour cream has good melt properties—without the tendency to separate or curdle.

It can be an objective of the present invention to provide soy sour cream products, that are lactose and/or cholesterol free, having the flavor, texture and aroma of traditional milk-based sour cream compositions. It is a related objective of the present invention to provide low fat, dairy-allergen free, preservative free and/or animal-byproduct free soy sour cream compositions that address the health and/or lifestyle requirements of a large number of consumers.

It is yet another objective of the present invention to provide dry or powdered soy sour cream compositions that can be used—in either a dry or a reconstituted form—alone or as an ingredient in a variety of foodstuffs. It is a related objective of the present invention to provide dry soy-based sour cream compositions that are easily transported without degradation of flavor or texture of the final soy sour cream or foodstuff product.

It can be yet another objective of the present invention to provide cultured soy base or starter compositions and methods of using such compositions in the preparation of high quality, tasteful soy sour cream and/or soy fermented compositions, wherein the cultured soy base includes a wide variety of soy constituents and lactic acid producing bacteria cultures.

Accordingly, it is an objective of the present invention to provide various soy sour cream compositions, thereby overcoming various deficiencies and shortcomings of the prior art, including those outlined above. It will be understood by those skilled in the art that one or more aspects of this invention can meet certain objectives, while one or more other aspects can lead to certain other objectives. Each objective may not apply equally, in all instances, to every aspect of the present invention. As such, these and other objects can be viewed in the alternative with respect to any one aspect of the present invention.

Other objects, features, benefits and advantages of the present invention will be apparent in this summary and descriptions of preferred embodiments, and will be readily apparent to those skilled in the art having the knowledge and experience in the area of soy food technology and nutrition. Such objects, features, benefits and advantages will be apparent from the above as taken in conjunction with the accompanying examples, data and all reasonable inferences to be drawn therefrom.

In part, the present invention is a method for preparing soy sour cream products. The method can include (1) providing an aqueous soy composition, (2) fermenting the soy composition with thermophilic bacteria, (3) incorporating at least one of an oil and a fat component with the fermented soy composition, and (4) heating the fermented soy composition to a temperature sufficient to deactivate at least a portion of the thermophilic bacteria culture. In preferred embodiments of the present invention, the method further includes incorporating at least one of a fat and an oil component with the aqueous soy composition and treating the soy composition at a pressure greater than about 2000 psi.

The soy composition utilized in the present invention is preferably a soy milk composition. The soy milk composition can be any aqueous or dehydrated soy milk product or composition known to those skilled in the art. Preferably, however, soy milk compositions used in the present invention include those as described in U.S. Pat. No. 6,322,846 to Gandhi et. al, and/or those as described in U.S. Pat. No. 6,663,912 to Gandhi et. al, incorporated herein, in their entirety, by reference. The soy milk composition can be manufactured from a variety of soy sources, as are well known to those skilled in the art, including, without limitation, whole ground soybeans, soybean flakes, soybean powder, soy flour, soy meal, soy grits, soy concentrate, soy isolate, soy tofu and/or combinations thereof. As such, the soy milk compositions suitable for use in the present invention include those containing whole soybean material. As described in U.S. Pat. No. 6,322,846 and U.S. Pat. No. 6,663,912, the soy milk compositions can be spray-dried and/or in powdered form and reconstituted for use in the present invention. Preferably, the soy milk composition will have a solids content from about 10 to about 14%.

Further, the soy milk compositions for use in the present invention can be completely defatted. Alternatively, the soy milk compositions utilized in the present invention can include a fat and/or an oil component. The soy milk compositions preferably contain from about 1.8% to 2.0% of a fat and/or an oil component. Such fat or oil component can be as described in U.S. Pat. No. 6,322,846, U.S. Pat. No. 6,663,912, or as described elsewhere herein.

Consistent with the broader aspects of the present invention, the soy composition utilized in the methods described herein can be any type of soy ingredient derived from a variety of soy sources including, without limitation, whole ground soybeans, soybean flakes, soybean powder, soy flour, soy meal, soy grits, soy concentrate, soy isolate, soy tofu, soy milk and/or combinations thereof. A dry or dehydrated soy composition can be combined with a sufficient amount of water to provide an aqueous soy composition.

The soy composition can also include a vegetable sugar component including, without limitation, dextrose, fructose, sucrose, glucose and/or maltose, in an amount sufficient to produce the desired fermentation effect in the resulting soy sour cream composition. Thus, the methods of the present invention contemplate the addition of such a sugar component to provide sufficient nutrient for fermentation of the soy composition. In particular, raw soy flour and/or soy particulate may require the addition of such a vegetable sugar component to achieve the required fermentation effect on the soy component.

The soy component and/or the soy milk composition can be blended with animal milk, such as cows milk, goats milk and/or a plant milk such as rice or coconut milk to achieve sour cream compositions having a reduced lactose content, or having additional nutritional requirements.

Unlike conventional cultured dairy sour creams, the present invention utilizes thermophilic bacterial cultures including at least one Streptococcus strain and at least one Lactobacillus strain. Streptococcus cultures preferably include, without limitation, a Streptococcus thermophilus culture. However, consistent with the present invention, any thermophilic Streptococcus bacterial culture known to those skilled in the art may be used. Lactobacillus cultures can include, without limitation, Lactobacillus bulgaricus, Lactobacillus helveticus, Lactobacill LIS lactis, Lactobacillus delbrueckii, Lactobacillus casei, Lactobacillus salivarius, Lactobacillus plantarum and/or combinations thereof. Such thermophilic bacterial cultures are preferably grown in non-dairy ingredients.

The thermophilic bacterial cultures of the present invention can be present in any number of concentration ratios, ranging from about 1 to about 99% Lactobacillus culture and from about 99 to about 1% Streptococcus culture. In highly preferred embodiments of the present invention, as demonstrated in Examples 1 and 3 described herein, the thermophilic bacterial cultures are utilized in a ratio of from about 80 to about 90% Lactobacillus bulgaricus and from about 10 to about 20% Streptococcus thermophilus. Without limitation to any theory or mode of operation, the combination of thermophilic bacterial cultures results in soy sour cream products having the texture, taste, aroma and quality characteristics typical of dairy sour creams. Thus, consistent with the broader aspects of the present invention, any preferred ratio of Lactobacillus and Streptococcus thermophilic bacterial cultures can be combined and concentrated for direct inoculation of the soy composition, providing soy sour cream compositions of consistent texture, flavor, aroma and quality.

The quantity of thermophilic bacterial cultures added to the soy composition can depend on, among other possible factors, the desired acidity of the end product, the fermentation temperature, and the desired taste, texture and/or viscosity of the sour cream end product. Use of a combination of thermophilic bacterial cultures and a range of bacteria cultures ratios results in a variety of soy sour cream compositions having any number of desired acidities, aromas, textures and flavors. Preferably, a desirable, high quality soy sour cream product can be achieved using from about 0.5 to about 3.5% by weight of thermophilic bacterial cultures. As will be readily apparent to those skilled in the art, any concentration of thermophilic bacterial cultures can be used to achieve the desired organoleptic qualities in the final soy sour cream product. As demonstrated in Examples 1 and 3, a ratio of about 100 mL to about 360 mL thermophilic bacterial cultures to about 100 gallons to about 200 gallons of soy milk mixture may be used in the present invention.

In alternate embodiments of the present invention, fermentation of the soy composition can additionally include incorporation of mesophilic bacteria cultures such as Streptococcus cremois, Streptococcus lactis, Streptococcus diacetylactis, Leuconostoc citrovorum, Leuconostoc lactis, and/or combinations thereof. Mesophilic bacteria cultures can be provided in limited amounts, for example, less than about 1%, depending on the desired taste and texture required in the resulting soy sour cream product.

Fermentation of the soy component with thermophilic bacterial cultures occurs at a temperature of about 30° C. to about 50° C., with fermentation occurring more preferably between about 41° C. to about 45° C., depending on the specific bacteria and concentrations used. Fermentation of the soy component continues until the soy sour cream composition reaches the desired acidity, depending on consumer tastes and/or the desired end use of the soy sour cream product. Preferably, fermentation occurs until the soy component reaches a pH of about 4.0 to about 5.0.

The methods of the present invention include heat treatment of the fermented soy composition to deactivate at least a portion of the active thermophilic bacterial cultures. Preferably, at least about 50% to about 100% of the thermophilic bacterial cultures are deactivated during heat treatment. Heat treatment of the soy sour cream compositions yields a product having very little residual active culture, providing the soy sour cream compositions of the present invention with increased stability, resistance to syneresis and longer shelf-life at room temperature than typical sour cream products.

Heat treatment of the soy sour creams of the present invention can occur for a time or a temperature sufficient to deactivate any desired amount of active thermophilic bacterial cultures. Accordingly, heat treatment can continue until deactivation of substantially about 100% of the thermophilic bacterial cultures is achieved, yielding a substantially aseptic sour cream product. Depending on the desired end use of the product, heat treatment can occur for a time sufficient to deactivate a portion of the total thermophilic bacterial cultures resulting in a sour cream product exhibiting reduced or substantially no syneresis at room temperature.

Typically, a temperature ranging from about 79° C. to about 90° C. is sufficient to deactivate the thermophilic bacterial cultures and discontinue further acidification of the fermented soy composition at room temperature. As illustrated in Examples 2, 4 and 7, heat treatment of the fermented soy composition occurs preferably at a temperature ranging from about 79° C. to about 82° C. for a time period of approximately about 5 minutes.

As will be well known to those skilled in the art, before final packaging of the soy sour cream product, irradiation, high pressure and/or high temperature sterilization and/or any aseptic processing technique known to those skilled in the art may be used in order to achieve an aseptic soy sour cream product. For example, after deactivation of at least a portion the thermophilic bacterial cultures, the soy sour cream product may be heat sterilized at temperatures ranging from about 105° C. to about 129° C. for about two to about three seconds at pressures from about 180 to about 200 psi, as recited in U.S. Pat. No. 4,873,094 to Pischke et al.

As described above, the methods of the present invention contemplate the addition of a fat and/or an oil component to achieve a soy sour cream product having the texture and consistency of typical dairy sour cream products. Before inoculation or fermentation, a fat and/or an oil component can be added to the soy composition in an amount that will not inhibit activity of the bacteria cultures, as would be well known to those skilled in the art. Preferably, such amount will not exceed approximately about 5% to about 10% by weight of a fat and/or an oil component.

After fermentation, any desired fat content can be achieved in the resulting soy sour cream composition. For example, according to the UDSA guidelines for the fat content of dairy sour cream products, a regular sour cream contains not less than 18% fat by weight. Lower fat dairy sour creams include “Reduced Fat Sour Cream” products having 13.5% or less total fat, “Light Sour Cream” products having 9% or less total fat, “Low Fat Sour Cream” products having 6% or less total fat and “Nonfat Sour Cream” products having less than 1% total fat.

Thus, the methods of the present invention permit control of the fat content of the resulting soy sour cream product. Through proper selection of a fat or an oil component, the soy sour cream products of the present invention can be augmented to fall within the recommended guidelines to achieve a regular, Reduced Fat, or Light soy sour cream product. As would be well-known to those skilled in the art, any commercially-available oil, fat or combination can be used. Canola oil, soy oil and/or vegetable shortening are preferred for certain compositions, while any vegetable oil such as corn or sunflower oil can also be used. In addition, any vegetable fat or animal fat known to those skilled in the art can be used. For example, dairy fats—including without limitation cream or butter—can be used with certain other compositions. A fat/oil component can also be provided by blending the resulting composition with an appropriate animal and/or cereal cream product.

Addition of a fat and/or an oil component is preferably followed by pressure treatment/homogenization of the soy composition. Thus, such pressure treatment can occur before fermentation and/or after fermentation at pressure sufficient to emulsify the soy composition. As stated herein, such pressure treatment will preferably occur at pressures greater than about 2000 psi.

Depending on the soy component starting material, the fat/oil content desired in the resulting soy sour cream and the concentration of water used, a stabilizing component may be added to improve texture and stability, e.g. to enhance the composition's resistance to syneresis (water separation). Suitable stabilizing components include, but are not limited to, pectin, gelatin, carboxy methyl cellulose, guar gum, gum arabic, gellan gum, gum ghatti, gum tragacanth, agar, algin, locust bean gum, xanthan gum, carrageenan, sodium alginate, potassium alginate, propylene glycol alginate, and any combination thereof. Preferably, a natural gum, such as guar gum or locust bean gum is used as a stabilizer in order to provide an “all-natural” soy sour cream product.

In addition, a starch component can also be incorporated into the sour cream composition, depending on the desired viscosity, heat resistance or shear resistance required of the resulting soy sour cream product. The starch component can include, for example, maltodextrin, corn starch, and/or modified tapioca starch used to enhance the texture and appearance of the soy sour cream product.

Other embodiments of the present invention can include acidification of the resulting soy sour cream compositions through the use of an acid and/or acid salt before or after fermentation of the soy composition. Such acids include food grade organic or inorganic acids, either alone or together with a suitable corresponding salt. Food grade acids can include, for example, acetic, citric, tartaric, fumaric, lactic and combinations thereof. Likewise, an acid salt can be used alone to achieve comparable results. For example, sodium citrate, potassium citrate and/or combinations of such salts can be used either alone or in combination with citric acid. Alternatively, in accordance with this invention, other food grade salts of mono- and/or polybasic acids can be used. As separate embodiments, the present invention can include use of food grade inorganic acids, the corresponding salts and/or combinations thereof. For example, various phosphate and/or bicarbonate salts can be used satisfactorily. The acid component can be used to adjust the pH of the soy composition, enhancing the flavor and/or texture of the resulting compositions, depending on the type of soy starting material utilized with this invention.

To enhance the nutritional and health benefits of the soy sour cream compositions of the present invention, the present invention can include the incorporation of a probiotic culture added after heat treatment of the fermented soy composition. Probiotic cultures can include, without limitation, Lactobacillus acidophilus, Lactobacillus casei, Lactobacillus rhamnosus, Bifidobacterium bifidum, Bifidobacterium longum, Saccharomyces boulardii and/or combinations thereof. Such cultures can be added in an amount sufficient to achieve a nutritional and/or therapeutic effect in the individual consuming the soy sour cream composition, as would be well known to those skilled in the art.

Thus, in part, the present invention also includes a room temperature, shelf-stable soy sour cream composition. Such composition includes the fermentation product of a soy component and at least one thermophilic bacterial culture, a fat component from less than about 9 weight percent to greater than about 30 weight percent of the sour cream composition and a stabilizer component, wherein about 50% to about 100% of the thermophilic bacterial cultures are inactive. In highly preferred embodiments, the sour cream composition is substantially absent from active thermophilic bacterial culture, providing a shelf-stable soy sour cream composition exhibiting no substantial syneresis at room temperature.

The soy component can include, but is not limited to, whole ground soybeans, soybean flakes, soybean powder, soy flour, soy meal, soy grits, soy concentrate, soy isolate, soy tofu, soy milk and/or combinations thereof. The soy component is fermented with thermophilic bacterial cultures, as described above. In particular, the soy component can be combined with an effective amount of thermophilic bacteria cultures to impart the desired acidity, texture, viscosity and aroma in the resulting soy sour cream composition. Preferably, the resulting soy sour cream composition has a pH from about 4.0 to about 5.0, and more preferably from about 4.1 to about 4.4.

The soy sour cream compositions of the present invention contain a fat and/or an oil component in an amount sufficient to provide the resulting soy sour cream products with the desired fat content and/or to fall within the recommended guidelines to achieve a regular, Reduced Fat, Light, Low Fat or Nonfat soy sour cream composition. The sour cream compositions, therefore, can contain a fat component present in amounts ranging from less than about 1% to greater than about 30%. As described herein, canola oil, soy oil and/or vegetable shortening are preferred for certain compositions, while any vegetable oil such as corn or sunflower oil can also be used. In addition, any commercially-available oil, fat or combination known to those skilled in the art can be used. Thus, the soy sour cream compositions provided by the present invention can be specifically designed to be partially or completely fat and/or cholesterol free.

As described herein, and depending on the desired texture and stability of the resulting soy sour cream product, the soy sour cream compositions of the present invention can contain an effective amount of a stabilizer or starch component to achieve any desired texture, viscosity and shelf-stability in the resulting soy sour cream composition. In other embodiments of the present invention, the soy sour cream compositions can include an acid or acid salt component to achieve a desired taste or texture in the final soy sour cream product. In still other embodiments of the present invention, a preservative may be added to increase the shelf-life and stability of the soy sour cream compositions.

The compositions of the present invention include, in certain embodiments, a flavor component including, without limitation, dairy, fruit, vegetable (chives, onion garlic, etc.), spice, salt, sweetener, chocolate, vanilla or combinations thereof. Preferably, the flavor component is naturally derived, depending on the requirements of the resulting soy sour cream product. Other embodiments of the present invention can include addition of any artificial GRAS food flavor, including artificial sweeteners, known in the art. Such flavor components are preferably of the type manufactured by Jeneil Biotech Inc. (Saukville, Wis.).

Optionally, in yet other embodiments, the soy sour cream compositions can include a preservative component such as an anti-microbial or anti-fungal component, depending on the desired end use of the soy sour cream product. Preservative components such as sorbic acid, benzoic acid, propionic acid, ethyl formate, sodium nitrate, dehydroacetic acid, and/or another GRAS food preservative can be included in the resulting soy sour cream compositions.

The resulting soy sour cream compositions can be packaged, refrigerated and stored until use. Alternatively, the soy sour cream compositions of the present invention can be dehydrated, by freeze or spray drying methods as would be commonly known to those skilled in the art, and later reconstituted for use either alone or as part of a recipe or foodstuff, as a dairy sour cream replacement. Further, such compositions can be frozen and/or pasteurized, depending on the desired end use of the soy sour cream product.

Consistent with the broader aspects of the present invention, the soy sour cream compositions of the present invention can be incorporated into a variety of recipes, dips, dressings and sauces, depending on the type of flavorings incorporated into the soy sour cream composition. Dehydrated soy sour cream compositions of the present invention may be particularly useful as an ingredient in a wide variety of foodstuffs such as meal replacement or energy bars, snack foods, bakery goods, dips or dry or powdered sauces, as a replacement for dairy-based sour cream ingredients.

Use of the soy sour cream compositions of the present invention provides a wide range of vegetarian, vegan, lactose free and/or cholesterol free soy-based food products. Additionally, the compositions of the present invention can be all natural and allergen free. Such soy sour cream compositions can be incorporated into foods as a replacement for animal-based sour cream products, having the organoleptic properties of dairy sour cream and the health and nutritional benefits of soy.

Further, in part, the present invention can include a method of using thermophilic bacterial cultures to prepare a soy culture base. The method includes providing an aqueous soy composition, fermenting the soy composition for a time and a temperature sufficient to acidify the soy composition, wherein the fermentation is substantially absent an animal sugar. The thermophilic bacterial cultures are provided in any ratio of Lactobacillus and Streptococcus thermophilic cultures as described herein.

The method of the present invention includes refrigeration of the resulting soy composition for use in the preparation of soy sour cream compositions. Alternatively, the fermented soy compositions produced as described herein, can be dehydrated, such as freeze or spray dried. This shelf-stable cultured soy base is light-weight, compact and has a lower shipping cost. As such, the dehydrated cultured soy base includes viable thermophilic bacteria cultures that can be reactivated upon the addition of an aqueous medium and utilized in the preparation of a wide variety of soy sour cream compositions. Such a reconstituted cultured soy base can provide a method for producing a soy sour cream product of consistent taste and quality. Reference is made to Example 6 herein.

Accordingly, in part, the present invention includes a cultured soy base for use in the manufacture of soy sour cream compositions. Such a composition can include a soy component, an effective amount of thermophilic bacterial cultures and a fat component. As demonstrated in the following examples, the cultured soy base of the present invention is preferably refrigerated for later use as a starter composition for the soy sour cream compositions of the present invention. However, as described elsewhere herein, the cultured soy base may be dehydrated and reactivated upon the addition of an aqueous medium for utilization as a base in the preparation of soy sour cream compositions.

### EXAMPLES OF THE INVENTION

The following non-limiting examples and data illustrate various aspects and features relating to the compositions and methods of this invention. Such aspects and features include the surprising and unexpected results obtained using a soy based starting material in conjunction with thermophilic bacterial cultures in the preparation of soy sour cream compositions; in particular, the smooth, creamy mouthfeel, aroma and taste characteristics achieved using components and/or process parameters otherwise not contemplated or thought not possible. It should, of course, be understood that these examples are included for illustrative purpose only and that the invention is not limited to the particular combinations of materials, conditions, properties or the like set forth herein. Comparable utility and advantages can be realized using various other methodologies and/or compositional embodiments consistent with the scope of this invention.

Equipment to make and use the present invention will be well-known to those skilled in the art. Various commercially-available one- or two-stage high pressure homogenizers can be used in accordance with the present invention; one such homogenizer is available from either the Rannie or Gaulian divisions of APV, of Wilmington, Mass.

All components and/or ingredients used in conjunction with the present invention are commercially available from sources well-known to those skilled in the art. Likewise, the various process parameters described herein can be readily modified by such individuals to account for variations in the identity or concentration of such components and ingredients or as required to achieve results in accordance with those described herein.

### Example 1

Preparation of a Cultured Soy Base.

| Ingredients | % by Weight of Mixture |
|---|---|
| Water | 83.20 |
| Dry Soy Milk Composition | 14.80 |
| Vegetable Shortening | 2.00 |
| Total | 100.00 |

(1) A jacketed tank was charged with 83.2 kilograms (kg) of water and was heated to a temperature between about 180-185° F. (82-85° C.).

(2) Approximately 2 kg of vegetable shortening was added and the temperature was maintained between about 180-185° F. (82-85° C.).

(3) Approximately 14.8 kg of dry soy milk composition was slowly added to the hot water with vigorous agitation until the soy milk for the cultured base reached a smooth, lump-free consistency while maintaining the temperature between about 180-185° F. (82-85° C.).

(4) After the soy milk reached a smooth consistency, heat treatment was continued between about 180-185° F. (82-85° C.) for about 20-25 minutes with good agitation to prevent burning of the soy milk.

(5) The soy milk mixture was cooled to about 120-125° F. (49-52° C.) and homogenized at about 2,000 to about 3,000 psi while maintaining temperature between 120-125° F. (49-52° C.).

(6) The temperature was adjusted to about 105 to about 110° F. (about 41-about 44° C.) and the mixture was inoculated with thermophilic bacterial cultures. The thermophilic bacterial cultures contained approximately about 80-about 90% Lactobacillus bulgaricus culture and about 10-about 20% Streptococcus thermophilus culture. The thermophilic bacteria cultures were added in a ratio of about 100 mL to about 360 mL to about 100 gallons to about 200 gallons of soy milk mixture. The mixture was well mixed to ensure proper distribution of the culture in the soy milk. The temperature was monitored and maintained at about 105-about 110° F. (about 41-about 44° C.).

(7) Agitation was stopped and the mixture was allowed to incubate until the pH of the soy milk reached about 4.8 to about 5.0. The pH was not permitted to drop below 4.8.

(8) When the pH of the cultured base reached about 4.8 to about 5.0, the mixture was agitated at the slowest possible speed and cooled very gently to about 40-45° F. (4-7° C.). The temperature of the cultured soy base was maintained at this temperature until used to prepare the soy sour cream.

### Example 2

Preparation of Soy Sour Cream. With reference to Example 1,
preparation of a soy sour cream product is prepared as follows:

| Ingredients | % by Weight of Mixture |
|---|---|
| Cultured Soy Base | 44.50 |
| Vegetable Shortening | 9.00 |
| Soybean Oil | 9.00 |
| Water | 28.00 |
| Stabilizer | 7.90 |
| Flavor | 1.60 |
| Total | 100.00 |

(1) A jacketed tank was charged with 9.0 kg vegetable shortening and heated to about 110-120° F. (43-49° C.) until the vegetable shortening melted, and 9.0 kg soybean oil was added.

(2) About 7.9 kg of a stabilizer component (or combination of stabilizer components) was added to the melted vegetable shortening and soybean oil mixture and the composition was mixed well.

(3) With continuous mixing, 44.5 kg of a soy culture base composition of Example 1a was added.

(4) Approximately 28 kg of water was added, with continuous mixing.

(5) The mixture was heated to a temperature of about 175 to about 180° F. (about 79 to about 82° C.) with adequate agitation to prevent burning of the soy sour cream. When a temperature of about 175 to about 180° F. (about 79 to about 82° C.) was reached, the sour cream was held at this temperature for about 5 minutes.

(6) About 1.6 kg of natural flavor was added to the soy sour cream in the tank and mixed well. The sour cream was then cooled to about 160-170° F. (71-77° C.).

(7) The resulting sour cream was homogenized at about 2,500 to about 3,000 psi while maintaining the temperature at about 160-170° F. (71-77° C.).

(8) The mixture was homogenized again at about 2,000 to about 3,000 psi for a second time while maintaining temperature at about 160-170° F. (71-77° C.).

(9) The sour cream composition was packed at about 160-170° F. (71-77° C.) and refrigerated. The resulting sour cream product contained no less than about 18% total fat, consistent with the USDA's regulations for regular, dairy sour creams.

### Example 3

Preparation of Cultured Soy Base.

| Ingredients | % by Weight of Mixture |
|---|---|
| Water | 84.40 |
| Dry Soy Milk Powder | 10.60 |
| Canola Oil | 5.00 |
| Total | 100.00 |

(1) A jacketed tank was charged with 84.4 kilograms (kg) of water and was heated to a temperature between 180-185° F. (82-85° C.).

(2) Approximately 5 kg of canola oil was added and the temperature was maintained between about 180-185° F. (82-85° C.).

(3) Approximately 10.6 kg of dry soy milk powder was slowly added to the hot water with vigorous agitation until the soy milk for the cultured base reached a smooth, lump-free consistency while maintaining the temperature between about 180-185° F. (82-85° C.).

(4) After the soy milk reached a smooth consistency, heat treatment was continued between about 180 to about 185° F. (about 82 to about 85° C.) for about 20-25 minutes with good agitation to prevent burning of the soy milk.

(5) The soy milk mixture was cooled to 120-125° F. (49-52° C.) and homogenized at about 7,500 to about 8,000 psi while maintaining temperature between about 120-125° F. (49-52° C.).

(6) The temperature was adjusted to about 105 to about 110° F. (about 41-about 44° C.) and the mixture was inoculated with thermophilic bacterial cultures. The thermophilic bacterial cultures contained approximately about 80-about 90% Lactobacillus bulgaricus culture and about 10-about 20% Streptococcus thermophilus culture. The thermophilic bacteria cultures were added in a ratio of about 100 mL to about 360 mL to about 100 gallons to about 200 gallons of soy milk mixture. The mixture was well mixed to ensure proper distribution of the culture in the soy milk. The temperature was monitored and maintained at about 105-about 110° F. (about 41-about 44° C.).

(7) Agitation was stopped and the mixture was allowed to incubate until the pH of the soy milk reached about 4.8 to about 5.0. The pH was not permitted to drop below about 4.8.

(8) When the pH of the cultured base reached about 4.8 to about 5.0, the mixture was agitated at the slowest possible speed and cooled very gently to about 40-45° F. (4-7° C.). The temperature of the cultured soy base was maintained at this temperature until used to prepare the soy sour cream.

### Example 4

Preparation of Soy Sour Cream. With reference to Example 3,
preparation of a soy sour cream product is prepared as follows:

| Ingredients | % by Weight of Mixture |
|---|---|
| Cultured Soy Base | 74.50 |
| Canola Oil | 10.00 |
| Water | 6.00 |
| Stabilizer | 8.00 |
| Flavor | 1.50 |
| Total | 100.00 |

(1) A jacketed tank was charged with 10.0 kg canola oil and about 8.0 kg of a stabilizer blend was added to canola oil and the composition was mixed well.

(2) With continuous mixing, 74.5 kg of the cultured soy base of Example 3 was added.

(3) Approximately 6 kg of water was added, with continuous mixing.

(4) The mixture was heated to a temperature of about 175 to about 180° F. (about 79 to about 82° C.) with adequate agitation to prevent burning of the soy sour cream. When a temperature of about 175 to about 180° F. was reached (about 79 to about 82° C.), the sour cream was held at this temperature for about 5 minutes.

(5) About 1.5 kg of natural flavor was added to the soy sour cream in the tank and mixed well. The sour cream was then cooled to about 160-170° F. (71-77° C.).

(6) The resulting sour cream was homogenized at about 2,000 to about 3,000 psi while maintaining the temperature at about 160-170° F. (71-77° C.).

(7) The mixture was homogenized again at about 2,000 to about 3,000 psi for a second time while maintaining temperature at about 160-170° F. (71-77° C.).

(8) The sour cream was packed at about 160-170° F. (71-77° C.) and refrigerated. The resulting reduced fat sour cream product contained less than about 18% total fat.

### Example 5a

With reference to Examples 1 and/or 3, a soy component, such as fine ground soy flour, soy flakes, soy powder, soy meal, soy grits, soy concentrate, soy isolate, soy tofu or a combination thereof can be substituted for the dry soy milk composition. Water is then added in a sufficient amount to provide an aqueous soy composition for use in the aforementioned example steps (4) through (8) above.

### Example 5b

With reference to Examples 1 and/or 3, an aqueous soy milk composition, including, without limitation, the soy milk compositions described in Examples 1 through 19 of U.S. Pat. No. 6,322,846 and U.S. Pat. No. 6,663,912 can be substituted for the dry soy milk composition. The soy milk composition may be homogenized before inoculation with the bacteria culture, as recited in example step(s) (5), above. Alternatively, the soy milk composition may not be homogenized before inoculation with fermentation occurring as recited in step (6) of Examples 1 and/or 3, above.

### Example 5c

With reference to any of the preceding examples, the soy milk component and/or the soy component can also include a vegetable sugar component, a buffer component, such as sodium citrate or potassium citrate, a stabilizer component and/or a starch component.

### Example 5d

With reference to any of the preceding examples, the thermophilic bacterial cultures may be present in any number of concentration ratios, ranging from about 1 to about 99% Lactobacillus culture and from about 99 to about 1% Streptococcus culture. The quantity of thermophilic bacterial culture added to the soy composition can depend on, among other possible factors, the desired acidity of the end product, the fermentation temperature, and the desired taste, texture and/or viscosity of the sour cream end product.

The type of thermophilic bacterial culture can be varied according to the requirements of the soy component starting material or the desired fermentation effect of the soy culture base. Streptococcus cultures can include, without limitation, a Streptococcus thermophilus. Lactobacillus cultures can include, without limitation, Lactobacillus bulgaricus, Lactobacillus helveticus, Lactobacillus lactis, Lactobacillus delbrueckii, Lactobacillus casei, Lactobacillus salivarius, Lactobacillus plantarum and/or combinations thereof.

### Example 5e

With reference to any of the preceding examples, the soy culture base is prepared without the addition of a fat component (i.e. without the canola oil recited in step (2) of Examples 1 or 3, above).

### Example 6a

With reference to Examples 2 and/or 4, the amount of water and stabilizer component utilized in the preparation of the soy sour cream composition may vary, depending on the fat content desired in the resulting soy sour cream product. As will be well known to those skilled in the art, if a reduced fat content is desired, water and stabilizer concentrations may be provided in an amount sufficient to provide the desired texture, viscosity and room temperature stability required in the resulting reduced or low-fat soy sour cream composition.

### Example 6b

With reference to Examples 2, 4, and/or 6a, the stabilizer component can include, without limitation, pectin, gelatin, carboxy methyl cellulose, guar gum, gum arabic, gellan gum, gum ghatti, gum tragacanth, agar, algin, locust bean gum, xanthan gum, carrageenan, sodium alginate, potassium alginate, propylene glycol alginate, or combinations thereof. In particular, guar gum, locust bean gum and the like can be used to provide a soy sour cream composition comprising natural ingredients.

### Example 6c

With reference to Examples 2, 4, 6a and 6b, the amount of soy culture base may be varied depending on a fat component used therewith and/or the fat content of the soy component or soy milk composition used in the preparation thereof. Likewise, any additional fat/oil incorporated may be varied depending on the overall fat content desired in the resulting soy sour cream product.

### Example 6d

With reference to any of the preceding Examples, notwithstanding the room temperature shelf-stability of the soy sour cream compositions of this invention, a preservative component such as an anti-microbial or anti-fungal component may be added, depending on the desired end use of the soy sour cream product. Preservative components such as sorbic acid, benzoic acid, propionic acid, ethyl formate, sodium nitrate, dehydroacetic acid, and/or another GRAS food preservative can be included in an amount sufficient to obtain the desired microbial resistance required in the resulting soy sour cream composition, as would be well known to those skilled in the art.

### Example 7

A cultured soy base is prepared as described Example 1f. Approximately 8.0 kg soybean oil is added to a jacketed tank and heated to a temperature of about 110-120° F. (43-49° C.). About 7.9 kg of a stabilizer blend is added to the soybean oil and the mixture is mixed well. With continuous mixing, approximately 44.5 kg of the cultured soy base of Example 1f is added. Approximately 28 kg of water is then added, with continuous mixing. The mixture is heated to a temperature of about 175-about 180° F. (about 79-about 82° C.) with adequate agitation to prevent burning of the soy sour cream. When a temperature of about 175-about 180° F. (about 79-about 82° C.) is reached, the sour cream is held at this temperature for about 5 minutes. About 1.6 kg of natural flavor is added to the soy sour cream in the tank and it is mixed well. The sour cream is then cooled to about 160-about 170° F. (about 71-about 77° C.). The resulting sour cream is homogenized at about 2,000 to about 3,000 psi while maintaining the temperature at about 160-about 170° F. (about 71-about 77° C.). The mixture can then be homogenized again at about 2,000 to about 3,000 psi for a second time while maintaining temperature at about 160-about 170° F. (about 71-about 77° C.). The sour cream composition is then packed at 160-170° F. (71-77° C.) and refrigerated. The resulting sour cream product contains less than about 9% total fat, consistent with the USDA's requirements for Light dairy sour creams.

### Example 8

With reference to Examples 1 and/or 3, the resulting cultured soy base is freeze dried or spray dried to a powder by methods as would be commonly known to those skilled in the art, for ease of transportation. The dried cultured soy base is reconstituted with a sufficient amount of water for further processing. The resulting reconstituted cultured soy base is stored at about 40-45° F. (4-7° C.) until used to prepare the soy sour cream.

### Example 9

With reference to any of the preceding examples, one or more of the following fat/oil components can be substituted for or used in combination with the referenced canola oil, soybean oil and/or vegetable shortening: safflower oil, corn oil, sunflower oil, palm oil, coconut oil, animal fat (milk or butter fat) or a combination thereof, as well as other fats, oil or combinations thereof, as would be well known to those skilled in the art. In particular, oils such as safflower oil, corn oil, sunflower oil, palm oil, coconut oil and/or soybean oil may be used in the preparation of low cholesterol or cholesterol free products.

### Example 10

A cultured soy base formulated as described in any of the preceding examples can be blended with the following liquid components which can comprise about 10% to about 50% of the total volume of the cultured soy base: animal milk, cereal milk and combinations thereof.

### Example 11

A cultured soy base or soy sour cream composition formulated as described in any of the preceding examples can be blended with a food grade acid and/or its corresponding acid salt to achieve a desired texture, acidity or pH for the resulting soy sour cream composition.

### Example 12

A soy sour cream composition formulated as described in any of the preceding examples can include the addition of a probiotic culture after deactivation or homogenization of the resulting soy sour cream product. The probiotic culture can be, without limitation, Lactobacillus acidophilus, Lactobacillus casei, Lactobacillus rhamnosus, Bifidobacterium bifidum, Bifidobacterium longum, Saccharomyces boulardii and/or combinations thereof. The probiotic culture can be included in a sufficient amount to provide the resulting soy sour cream with a nutritious or therapeutic effect, as would be well known to those skilled in the art.

### Example 13a

A soy sour cream composition formulated as described in any of the preceding examples, prior to homogenization, a 1% milk flavoring is added to the soy mixture. The flavoring component of this example can be one or more of several commonly used in animal or cereal milks/beverages, including without limitation, chocolate, vanilla and various fruit flavorings. Such flavor components can be obtained from Jeneil Biotech Inc., of Saukville, Wis.

### Example 13b

A soy sour cream composition formulated as described in any of the preceding examples can include the addition of a flavoring component such as chives, onion, garlic or other seasoning for use in a variety of dips, dressings and/or sauces.

### Example 14

With reference to Examples 2, 4, 7, 13 and/or variations thereof as provided in the other examples described herein, the resulting soy sour cream composition is freeze dried or spray dried to a powder by methods as would be commonly to those skilled in the art, for ease of transportation and incorporation into a variety of foodstuffs (e.g. power/energy bars, crackers or potato chips). Alternatively, the dried soy sour cream composition may be reconstituted with a sufficient amount of an aqueous medium and stored at a temperature of about 40 to about 45° F. (about 4 to about 7° C.) until ready for use (e.g. instant dips, dressings, or sauces such as dry packaged sour cream ingredients for use in stroganoff, snack foods, bakery goods and related food products.)

### Example 15

With reference to Examples 2, 4, 7, 13 and/or variations thereof as provided in the other examples described herein, the resulting soy sour cream composition may be subject to irradiation, high pressure and/or high temperature sterilization and/or any aseptic processing technique known to those skilled in the art to achieve an aseptic soy sour cream product. For example, after deactivation of at least a portion the thermophilic bacterial cultures, the soy sour cream product may be heat sterilized at temperatures ranging from about 105° C. to about 129° C. for about two to about three seconds at pressures from about 180 to about 200 psi, as recited in U.S. Pat. No. 4,873,094 to Pischke et al.

1. A method for preparing a soy sour cream composition comprising:
providing an aqueous soy composition;
fermenting said soy composition with thermophilic bacteria;
incorporating at least one of an oil and a fat component and said fermented soy composition; and
heating said fermented soy composition to a temperature sufficient to substantially deactivate about 50% to 100% of said thermophilic bacteria.

2. The method of claim 1 wherein said aqueous soy composition comprises a soy milk.

3. The method of claim 1 wherein said aqueous soy composition comprises water, a dry whole soybean particulate and at least one of a food grade acid and a salt of said acid.

4. The method of claim 1 further comprising incorporating a fat component with said aqueous soy composition and treating said soy composition at a pressure greater than about 2,000 psi.

5. The method of claim 1 wherein said fermented soy composition is heated for at least one of a time and a temperature sufficient to substantially discontinue fermentation.

6. The method of claim 5 wherein said fermented soy composition is heated for at least one of a time and a temperature sufficient to provide a substantially aseptic sour cream composition.

7. The method of claim 1 further comprising treating fermented soy composition at a pressure greater than about 2000 psi.

8. The method of claim 1 further comprising dehydrating said fermented soy composition.

9. The method of claim 8 wherein said fermented soy composition is spray dried.

10. The method of claim 8 comprising addition of water to reconstitute said dehydrated soy composition.

11. A process for preparing a sour cream product comprising:
providing an aqueous soy composition;
fermenting said aqueous soy composition with at least one thermophilic bacterial culture;
incorporating at least one of an oil and a fat component and said fermented soy composition;
stabilizing said fermented soy composition; and
heating said fermented soy composition to a temperature sufficient to provide a substantially aseptic sour cream product.

12. The process of claim 11 wherein said fat and said oil component is selected from the group consisting of animal fats, vegetable oils, vegetable fats and combinations thereof.

13. The method of claim 11 wherein said thermophilic bacterial culture comprises at least one Lactobacillus strain and at least one Streptococcus strain.

14. The method of claim 11 further comprising adding a food grade acid to adjust the pH of the fermented soy composition.

15. A method of using thermophilic bacterial culture to prepare a base soy composition, said method comprising:
providing an aqueous soy composition;
introducing at least one thermophilic bacterial culture to said composition; and
fermenting said soy composition for a time and at a temperature sufficient to acidify said soy composition, said fermentation substantially absent an animal sugar.

16. The method of claim 15 further comprising incorporation of said fermented composition with a fat component sufficient to provide a sour cream.

17. The method of claim 15 further comprising dehydrating said fermented soy composition.

18. A room temperature, shelf-stable soy sour cream composition comprising the fermentation product of a soy component and thermophilic bacterial culture, a fat component from less than about 9 weight percent to greater than about 30 weight percent of said composition, and a stabilizer component; wherein about 50% to 100% of said bacteria are inactive.

19. The composition of claim 18 wherein said soy component comprises at least one of a soy milk product, soy flakes, soy powder, soy flour, soy meal, soy grits, soy concentrate, soy isolate, soy tofu and combinations thereof.

20. The composition of claim 19 wherein said soy milk product comprises a dry whole soybean particulate and at least one of a food grade acid and a salt of said acid.

21. The composition of claim 18 wherein said thermophilic bacterial culture comprises at least one Lactobacillus strain and at least one Streptococcus strain.

22. The composition of claim 21 wherein said thermophilic bacterial culture comprises from about 1 to about 99% Lactobacillus bacteria and from about 99 to about 1% thermophilic Streptococcus bacteria.

23. The composition of claim 21 wherein said Lactobacillus strain comprises Lactobacillus bulgaricus and said Streptococcus strain comprises Streptococcus thermophilus.

24. The composition of claim 18 wherein said fat component is selected from the group consisting of animal fats, vegetable oils, vegetable fats and combinations thereof.

25. The composition of claim 18 wherein said stabilizer component comprises pectin, gelatin, carboxy methyl cellulose, guar gum, gum arabic, gellan gum, gum ghatti, gum tragacanth, agar, algin, locust bean gum, xanthan gum, carrageenan, sodium alginate, potassium alginate, propylene glycol alginate, or combinations thereof.

26. The composition of claim 18 further comprising at least one probiotic culture selected from the group consisting of Lactobacillus acidophilus, Lactobacillus casei, Lactobacillus rhamnosus, Bifidobacterium bifidum, Bifidobacterium longum, Saccharomyces boulardii and combinations thereof.

27. The composition of claim 18 further comprising a flavor component selected from dairy, fruit, vegetable, spice, salt, natural sweetener, artificial sweetener, chocolate, vanilla or combinations thereof.

28. A sour cream composition comprising:
the fermentation product of a soy component and at least one active thermophilic bacterial culture; and
at least one of a fat and an oil component,
wherein said sour cream composition is substantially absent active thermophilic bacterial culture.

29. The composition of claim 28 wherein said soy component comprises soy milk.

30. The composition of claim 28 wherein said thermophilic bacterial culture comprises from about 1 to about 99% Lactobacillus bacteria and from about 99 to about 1% thermophilic Streptococcus bacteria.

31. The composition of claim 28, where said sour cream composition comprises from about 1% to about 30% of said fat and said oil component, wherein said fat and said oil component is selected from the group consisting of animal fats, vegetable oils, vegetable fats and combinations thereof.

32. The composition of claim 28, further comprising at least one flavor component selected from dairy, fruit, vegetable, spice, salt, natural sweetener, artificial sweetener, chocolate, vanilla or combinations thereof.

33. The composition of claim 28, wherein said sour cream composition is dehydrated.
